(19) United States
(12) Patent Application Publication
(10) Pub. No.: US 2006/0293930 A1
(43) Pub. Date: Dec. 28, 2006

(54) Sales call management

(76) Inventors: Edward Briscoe Rodgers, Boston, MA (US); Anthony N. Deigh, Cambridge, MA (US); Lucinda J. Long, Cambridge, MA (US)

Correspondence Address: FISH & RICHARDSON PC, P.O. BOX 1022, MINNEAPOLIS, MN, 55440-1022, US

(21) Appl. No.: 11/165,310

(22) Filed: Jun. 23, 2005

(51) Int. Cl. G06Q 99/00; G06Q 10/00

(52) U.S. Cl. 705/5; 705/1

(57) ABSTRACT

Slots for sales calls to be made by sales representatives to sales targets are generated, reserved, delivered, managed, stored, analyzed, reported, and used.

A computer program listing appendix is submitted on one compact disk and is incorporated by reference here. The disk contains files named iText.txt, PreferredTime.txt, RepWireJava.txt, schema.txt, and simpleORM.txt.

### BACKGROUND

This description relates to sales call management.

Personnel in the healthcare field (“staff”) in medical offices (“offices”) and industry sales representatives (“reps”) often meet to discuss products and transfer product literature and samples. These sales calls typically occur in an ad-hoc fashion in which reps arrive unexpectedly at an office and may wait for long periods of time in the lobby. Even after waiting, these sales calls sometimes fail because the staff member the rep is seeking is not available.

Some staff use paper to manually organize sales call slots (“slots”). These slots may be for visits with physicians, sample deliveries at the front desk, group lunches, coffee breaks, or other types of sales calls. Some staff employ a daily paper rep sign-in sheet to log sales calls and sample deliveries, to establish a queue of reps, or to limit the total number of sales calls per day. Some staff maintain paper calendars to organize slots with specific reps on future days.

### SUMMARY

In general, in one aspect, available slots are automatically generated for sales calls to be made by sales representatives to sales targets, and reservations for one or more of the available slots are enabled to be made electronically on behalf of one or more sales representatives or entities represented by the sales representatives, the making of the reservations including interfacing with a sales management software tool.

Implementations may include one or more of the following features. The sales management tool comprises a sales force automation system. The sales management tool comprises a computer-based calendar. The available slots comprise time slots. The one or more users are enabled to specify conditions for generating the available slots. The one or more users comprise staff of the sales targets. Sign-in lists are delivered electronically to the sales targets based on the slots. The conditions comprise rules. The conditions relate to time. The conditions comprise specified days or times. The conditions relate to a number of slots per period. The conditions relate to generation of ad hoc slots created in real time. The reservations are automatically made for fixed recurring times. The sales targets comprise health care providers. The sales representatives represent pharmaceutical or medical device suppliers.

The conditions comprise limits on frequency of slots per sales representative or per entity represented by the sales representatives. The conditions comprise limits on a percentage of slots that can be reserved on behalf of a sales representative or an entity represented by the sales representatives. The conditions comprise limits on the number of slots per time period for a given sales target. The slots reserved on behalf of entities are later assigned or reassigned to sales representatives. Wait listing is enabled for available slots on behalf the sales representatives or entities. Stand-by status is enabled for available slots. The reservations are enabled to be made only up to a minimum time prior to the time of a slot being reserved. The reservations are enabled to be made only after a maximum time prior to the time of a slot being reserved. The reservations are enabled to be made based on an extent to which the sales targets' slots are filled. The conditions include restrictions on the number of calls of a type that can be made in a given day. At least one of the conditions applies only to certain types of sales calls. The available slots are limited to pre-specified sales representatives or entities. A schedule of the slots is optimized with respect to one or more of the sales representatives, the entities, and the sales targets, subject to the defined conditions. The schedule is optimized for a sales representative with respect to slots for different sales targets. Recommendations are provided to the sales representatives or the entities to reserve slots with respect to identified sales targets. The identified sales targets are identified based on historical information about sales calls made to sales targets. Advertising is exposed to the sales targets or users in connection with the enabling of the reservations. The advertising is included on sign-in lists. The advertising is selected based on identities of the sales representatives or entities on whose behalf slots have been reserved. The advertising is associated with slots for communication to sales representatives for whom the slots are reserved. Reports are provided of sales calls completed or planned, by matching sales representative products against a sales target's formulary. A directory is automatically generated of sales representatives based on reservations for available slots. Information is broadcast about sales calls to sales representatives who have reservations for a specific sales target or targets. The entities represented by the sales representatives comprise pharmaceutical companies, and information is reported about sales calls to the pharmaceutical companies. Communicating is done with the sales representatives or entities after the reservations have been made and prior to the times of the slots concerning the slots. The communicating includes reminders. The communicating includes invitations for available slots to the sales representatives or entities. The invitations are based on frequencies of slot reservations by the sales representatives or entities. The conditions comprise rules that define available slots and filters that define permitted uses of the available slots by the sales representatives.

In general, in another aspect, based on stored information about electronically reserved slots for sales calls to be made by sales representatives to sales targets, displayable schedules of the sales calls are provided electronically at a site at which the calls are to be made information about completed sales calls appears on the schedules.

In general, in another aspect, staff of physicians are enabled to electronically define conditions for generating slots for sales calls to be made by sales representatives of pharmaceutical or medical device companies on the physicians at places where the physicians are located, the sales representatives are enabled electronically to make reservations for generated slots, sign-in lists are generated of slots that have been reserved for use at the places where the physicians are located, information may be added to the sign-in lists related to completed sales calls, and the added information is returned to a central location for storage and future use.

In general, in another aspect, on pre-generated lists of reserved slots for sales calls to be made by sales representatives to sales targets places where the sales targets are located, information is obtained about the sales calls, and the pre-generated lists and obtained information are provided electronically to a central location from the different places. Implementations may include one or more of the following features. The obtained information includes information about at least one of the following: samples of products that interest the sales targets, notes about the sales calls, and messages for the sales representatives or the sales targets. The obtained information comprises information about samples of products delivered to the sales targets in connection with the sales calls. The obtained information comprises one or more of product identification, lot number, arrival time, and expiration date. The obtained information is archived at the central location. The sales target requests samples of products in connection with the visits. Sales representatives are automatically selected based on past call activity, and invitations are automatically sent for available slots to the sales representatives. Special time slots are made available to those sales representatives.

In general, in another aspect, from a central location to places at which sales representatives are scheduled to make sales calls on sales targets, schedules of slots for the sales calls are delivered electronically, and after the schedules are delivered, information is received at the central location information about the sales calls, the delivered schedules including lists of the slots and a mechanism for recording product samples associated with the sales calls.

Implementations may include one or more of the following features. The schedule also includes a mechanism to record preferences regarding future sales calls. The schedule also includes a mechanism to record messages. The schedule conforms to the layout shown in figure. Agreement with sales call policies of the sales targets is obtained in connection with permitting reservations for slots for the sales targets.

In general, in another aspect, a pharmaceutical company sends sales representatives to call on physicians for sales slots that have been reserved using an electronic reservation mechanism that matches slots for which the physician commits to be available for such sales representatives and communicates with a sales force automation system.

In general, in another aspect, a physician makes himself available for sales slots for sales representatives of pharmaceutical companies that have been reserved using an electronic reservation mechanism in which conditions for availability of the sales slots to the sales representatives are controlled on behalf of the physician and which automatically generates a directory of sales representatives.

In general, in another aspect, one or more users are enabled to define conditions for generating slots for sales calls to be made by sales representatives to sales targets, reservations of one or more of the slots are enabled to be made electronically on behalf of one or more sales representatives or entities represented by the sales representatives, and automatic delivery is made for use on behalf of the sales targets sign-in lists of slots that have been reserved, on behalf of sales representatives or the entities, with respect to the sales targets.

In general, in another aspect, a user is enabled to define a rule for generating slots for sales calls to be made by sales representatives to a sales target, reservations are enabled of one or more of the slots generated using the rule to be made electronically on behalf of one or more sales representatives or entities represented by the sales representatives, and automatic delivery is done, for use on behalf of the sales target, of a list of slots subject to reservations of sales representatives or the entities with respect to the sales target.

In general, in another aspect, a user is enabled to define a condition for generating in real time ad hoc slots for sales calls to be made by sales representatives to a sales target, reservations of one or more of the ad hoc slots are enabled to be made electronically on behalf of one or more sales representatives or entities represented by the sales representatives, and, for use on behalf of the sales target, a list of the ad hoc slots and reservations are automatically delivered.

In general, in another aspect, with respect to one or more slots for sales calls that are to be made by sales representatives to a sales target, reservations are enabled to be made automatically for fixed recurring times on behalf of one or more sales representatives or entities represented by the sales representatives.

In general, in another aspect, a user is enabled to define a condition for generating slots for sales calls to be made by sales representatives to a sales target, the condition comprising a limit on an amount of slots that can be generated, and reservations of one or more of the slots are enabled to be made electronically on behalf of one or more sales representatives or entities represented by the sales representatives.

Implementations may include one or more of the following features. The conditions comprise limits on frequency of slots per sales representative or per entity represented by the sales representatives. The conditions comprise limits on a percentage of slots that can be reserved on behalf of a sales representative or an entity represented by the sales representatives. The conditions comprise limits on the number of slots per time period for a given sales target.

In general, in another aspect, slots for sales calls to be made by sales representatives to a sales target are automatically generated, reservations of one or more of the slots are enabled to be made electronically on behalf of one or more sales representatives or entities represented by the sales representatives, and the assignments of slots are adjusted after the reservations have been made.

Implementations may include one or more of the following features. The slots reserved on behalf of entities are later assigned or reassigned to sales representatives. Wait listing is enabled for available slots on behalf the sales representatives or entities. Stand-by status is enabled for available slots.

In general, in another aspect, slots for sales calls to be made by sales representatives to a sales target are automatically generated, reservations of one or more of the slots are enabled to be made electronically on behalf of one or more sales representatives or entities represented by the sales representatives, and the time period during which reservations for slots may be made is constrained.

Implementations may include one or more of the following features. The reservations are enabled to be made only up to a minimum time prior to the time of a slot being reserved.

The reservations are enabled to be made only after a maximum time prior to the time of a slot being reserved.

In general, in another aspect, automatically generating slots for sales calls to be made by sales representatives to a sales target, enabling reservations of one or more of the slots to be made electronically on behalf of one or more sales representatives or entities represented by the sales representatives, the reservations being enabled to be made based on an extent to which the sales targets' slots are filled.

In general, in another aspect, a user is enabled to define a condition for generating slots for sales calls to be made by sales representatives to sales targets, and reservations of one or more of the slots are enabled to be made electronically on behalf of one or more sales representatives or entities represented by the sales representatives, the condition applying only to certain types of the sales calls.

In general, in another aspect, available slots for sales calls to be made by sales representatives to a sales target are automatically generated, the available slots being limited to prespecified sales representatives or entities. and reservations of one or more of the slots are enabled to be made electronically on behalf of one or more sales representatives or entities represented by the sales representatives.

In general, in another aspect, a user is enabled to define a condition for generating slots for sales calls to be made by sales representatives to a sales target, and a schedule of the slots is optimized subject to the defined condition. Implementations may include one or more of the following features. The schedule is optimized for a sales representative with respect to slots for different sales targets.

In general, in another aspect, available slots are generated for sales calls to be made by sales representatives to sales targets, and recommendations are automatically provided to the sales representatives or entities which they represent to reserve slots with respect to an identified sales target. Implementations may include one or more of the following features. The identified sales targets are identified based on historical information about sales calls made to sales targets.

In general, in another aspect, reservations of one or more slots for sales calls are enabled to be made electronically on behalf of one or more sales representatives or entities represented by the sales representatives, the sales calls being calls to a sales target, a sign-in list for sales call slots is automatically generated based on the reservations, and advertising is exposed to the sales target or the user in connection with the enabling of the reservations or the use of the sign-in list.

In general, in another aspect, a user is enabled to define a condition for generating slots for sales calls to be made by sales representatives to sales targets, and reservations of one or more slots for sales calls are enabled to be made electronically on behalf of one or more sales representatives or entities represented by the sales representatives, the sales calls being calls to a sales target, and information related to the sales calls is reported to the sale representatives, the entities, or the sales targets.

Implementations may include one or more of the following features. The reporting of information comprises providing reports of sales calls completed or planned. The reporting of information comprises providing reports of sales calls completed or planned, by matching sales representative products against a sales target's formulary. The reporting of information comprises automatically generating a directory of sales representatives based on reservations for available slots. The reporting of information includes broadcasting information about sales calls to sales representatives who have reservations for a specific sales target or targets. The entities represented by the sales representatives comprise pharmaceutical companies, and in which reporting information comprises reporting information about sales calls to the pharmaceutical companies. The information comprises information about samples of products delivered to the sales targets in connection with the sales calls.

In general, in another aspect, available slots for sales calls to be made by sales representatives to a sales target are automatically generated, reservations of one or more slots for sales calls are enabled to be made electronically on behalf of one or more sales representatives or entities represented by the sales representatives, and reminders are automatically provided to the sales representatives or entities which they represent, in advance of the times of the slots.

In general, in another aspect, available slots for sales calls to be made by sales representatives to sales targets are automatically generated, reservations of one or more slots for sales calls are enabled to be made electronically on behalf of one or more sales representatives or entities represented by the sales representatives, and invitations are automatically generated for available slots to sale representatives. Implementations may include one or more of the following features. The invitations are based on frequencies of slot reservations made by the sales representatives or entities.

In general, in another aspect, a user is enabled to specify rules for available slots for sales calls to be made by sales representatives to sales targets, filters are applied to the available slots to define permitted uses of the available slots by particular sales representatives or entities that they represent, and reservations of one or more slots for sales calls are enabled to be made electronically on behalf of one or more sales representatives or the entities.

Implementations may include one or more of the following features. Sales representatives are automatically selected based on past call activity, and invitations for available slots are automatically sent to the sales representatives. In some implementations, special time slots are automatically made available to those sales representatives.

In general, in another aspect, available slots for sales calls to be made by sales representatives to sales targets are automatically generated, reservations of one or more slots for sales calls are enabled to be made electronically on behalf of one or more sales representatives or entities represented by the sales representatives, and agreement with sales call policies of the sales targets is obtained in connection with making of reservations for slots for the sales targets.

Among the advantages of implementations of the invention are one of more of the following. The amount of effort required by staff to organize sales calls and communicate with reps is reduced. The reps can reserve, cancel, and schedule slots without being physically present or speaking with staff. The organization of all types of sales calls and activities can be automated, including sample deliveries, lunches, dinners, breakfasts, coffee breaks, visits with groups of staff members, and visits with specific staff members. Sales calls can be organized based on complex rules established by staff, such as automatically limiting the frequency of sales calls of a rep, limiting the percentage of slots taken by a rep, or limiting the total number of sales calls in a multi-day period. Travel routes for reps can be optimized based on the availability of slots. Collaborative filtering functionality can be used to recommend offices that a rep should visit based on the activity of other reps. The best days or times for reps to reserve slots can be recommended based on the results of previous sales calls. Messages or advertisements can be sent to staff prior to a sales call. Office policies, directions, and other information about the office can be sent to reps prior to sales calls. Activity reports can be provided for the office, staff, reps, or sales force managers. Staff can broadcast messages to all reps that call on their office. Reservation confirmations, reminders, or frequency-based invitations can be sent to reps. A rep managers can reserve a slot for his company or product, and then update the reservation later with the information for a specific rep who will take the slot. Staff can automatically find the appropriate rep to request a sales call to discuss a particular product, contact that rep, and reserve a sales call time slot to fill that request. A standardized sign-in sheet can be automatically generated and sent, which can be used for logging activity, digital archiving, and indicating requests. An office policy can be presented to a rep and agreement to that policy can be archived prior to allowing a rep to reserve a slot.

Other advantages and features will become apparent from the following description and claims.

### DESCRIPTION

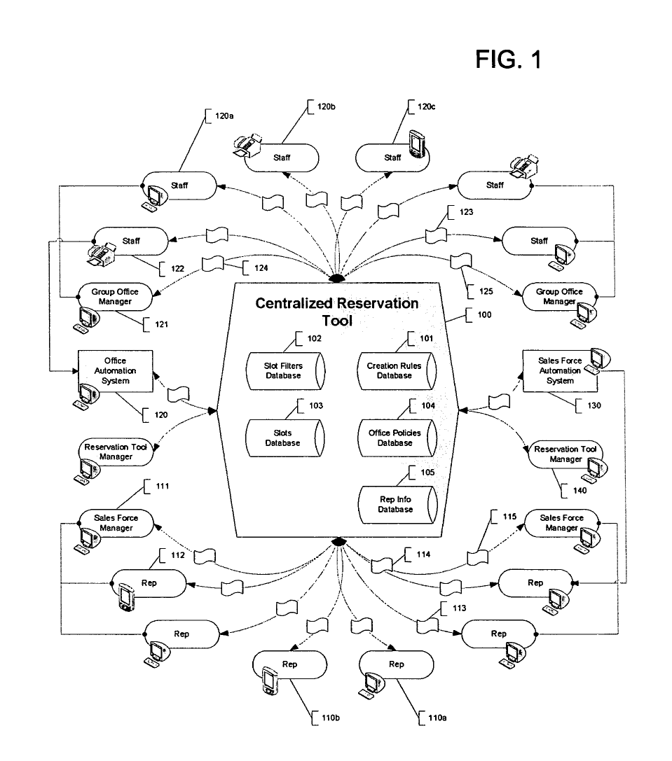

FIG. 1 is a block diagram of users of the centralized reservation tool.

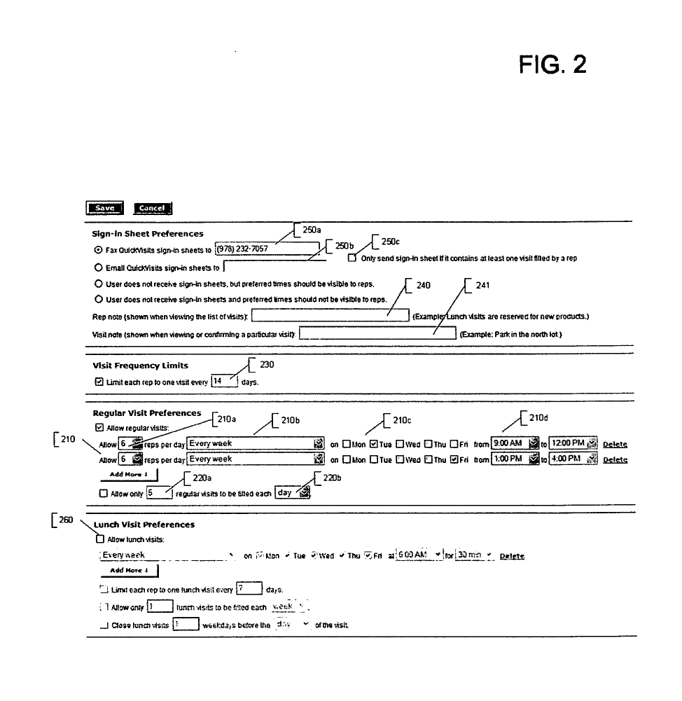

FIG. 2 is a screen shot of a dialog for staff to enter rules into a sales call reservation tool.

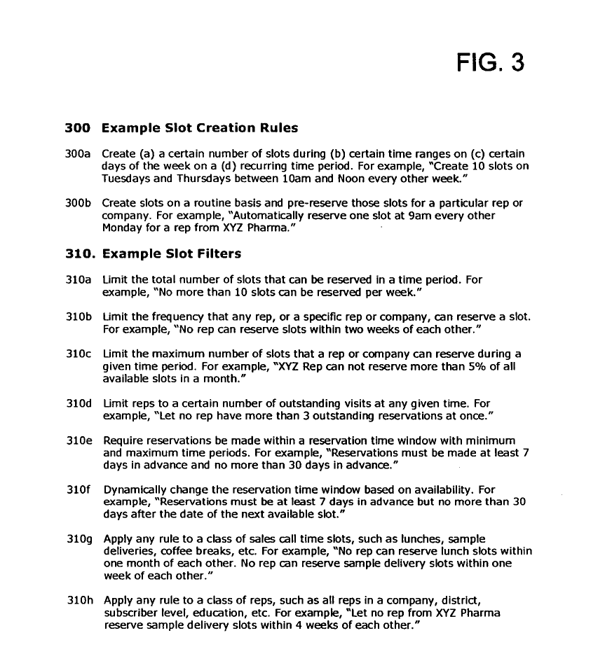

FIG. 3 is a partial list of rules that can be entered by reps or rep managers.

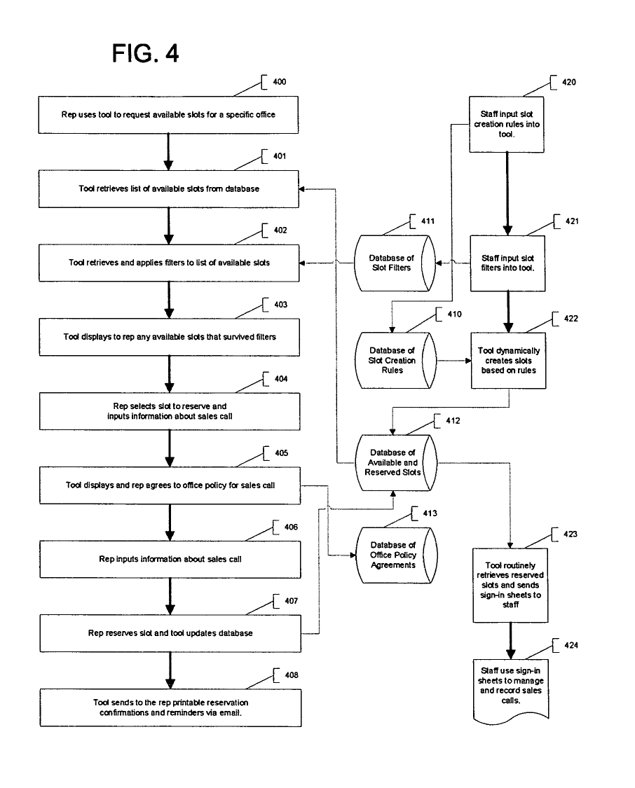

FIG. 4 is a flowchart of a method to reserve sales calls.

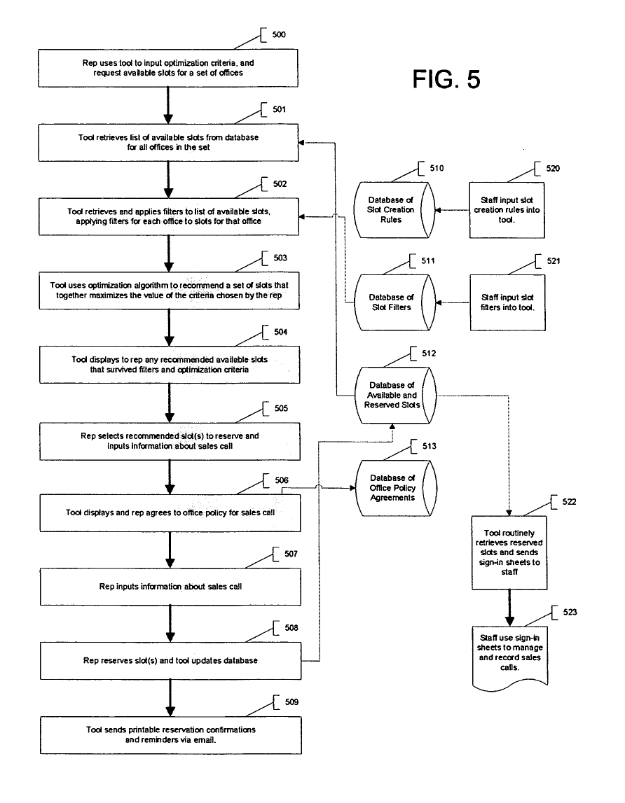

FIG. 5 is a flowchart of a method to reserve and optimize sales calls.

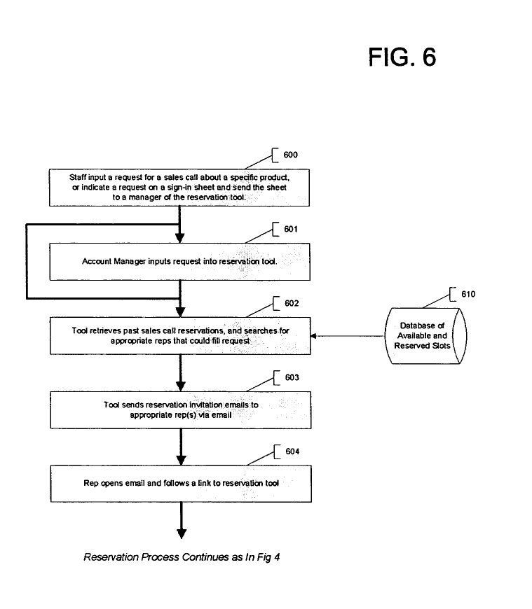

FIG. 6 is a flowchart of a method to request and reserve a sales call for a product.

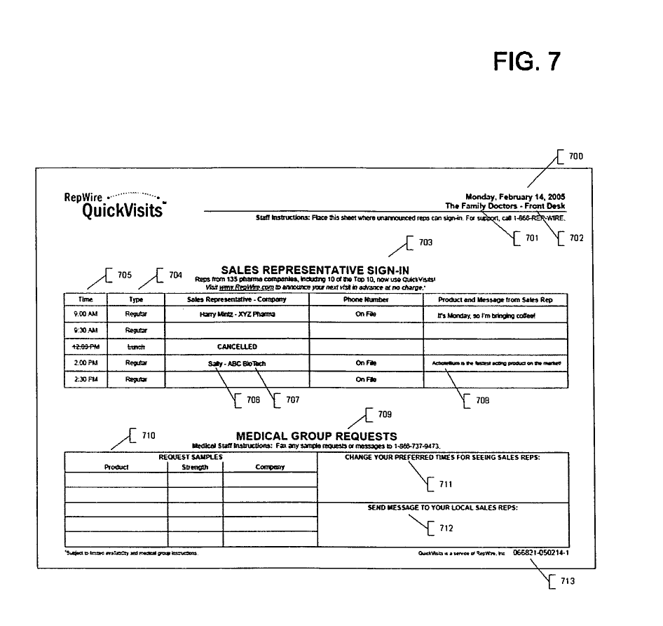

FIG. 7 is a layout of a sign-in sheet sent by the reservation tool.

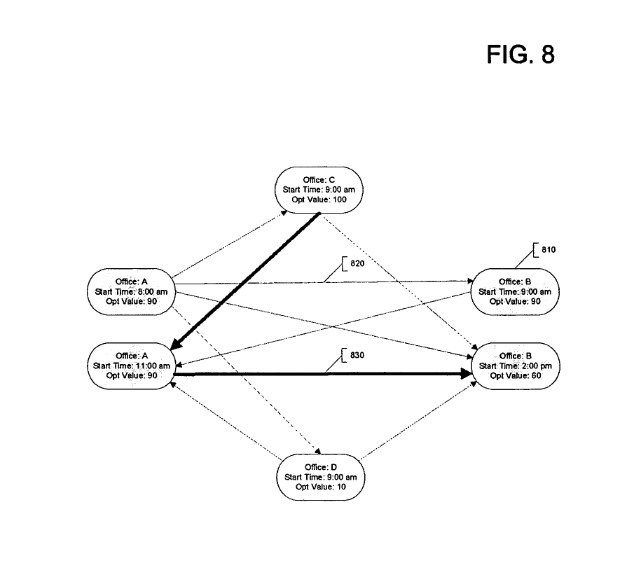

FIG. 8 is a vector graph of available slots that could be reserved by a rep.

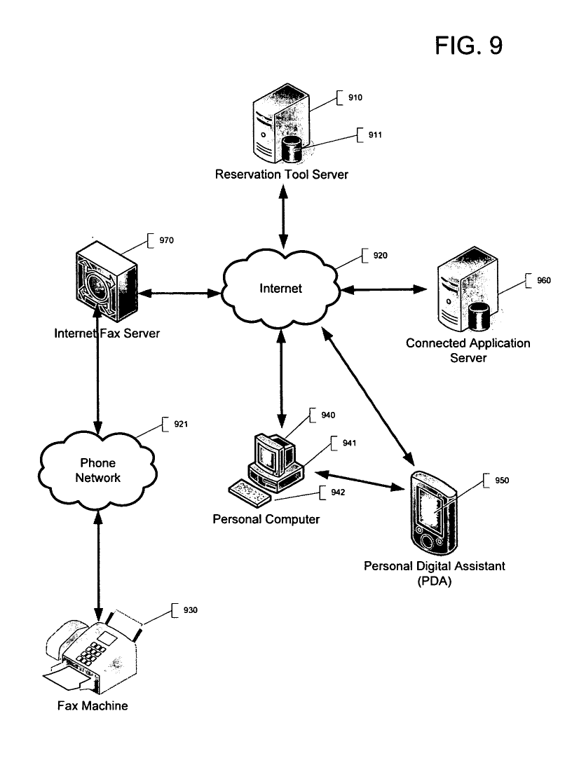

FIG. 9 is a block diagram of hardware used in the reservation tool.

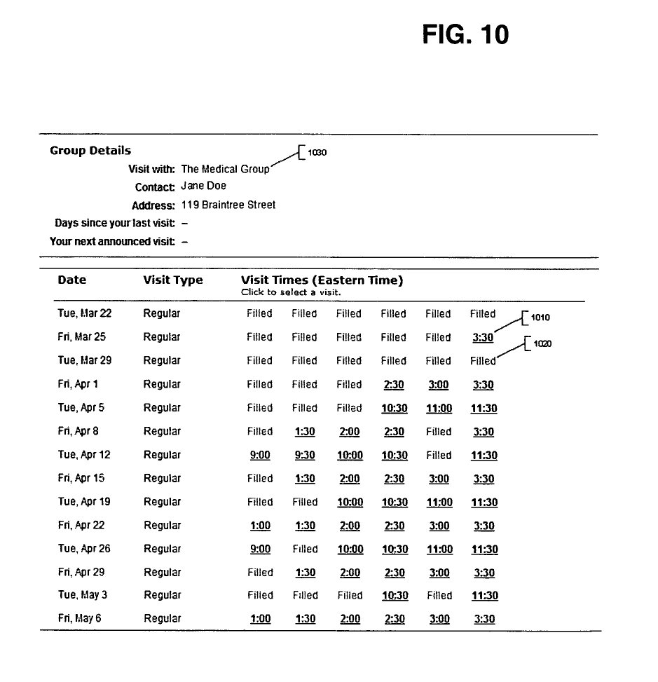

FIG. 10 is a screen shot of a dialog for reps to select and reserve slots

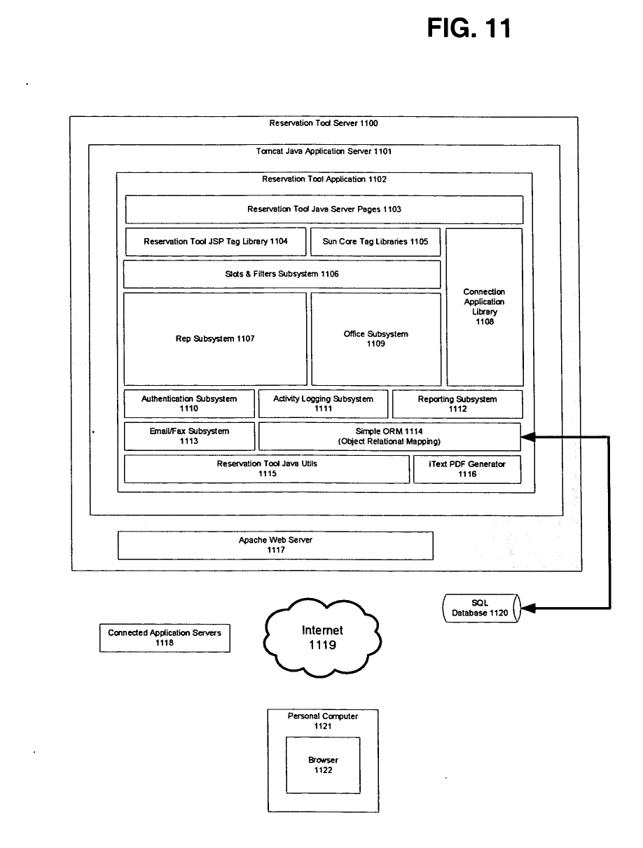

FIG. 11 is a block diagram of the reservation tool application architecture.

As shown in FIG. 1, sales call slots for reps calling on offices and staff can be organized and reserved using a sales call reservation tool 100.

The reservation tool 100 is centralized so that many different (related and unrelated) reps and other parties may use the reservation tool to access, search, and reserve sales call time slots created by many different (related and unrelated) offices and staff members. By centralized, we mean that, for example, at least part of the centralized reservation tool is not located with any of the offices, staff, and reps but rather interacts with the offices, staff, and reps through communication links from a separate location. In some cases, that part of the reservation tool can be operated on a single computer at a central location and in others, its operation can be distributed among more than one location (including one or more of the locations of the offices, staff, or reps.)

Staff 120a, 120b, 120c, 122 (staff can include but need not be limited to physicians, therapists, nurses, secretaries) use the reservation tool to define slot creation rules (“creation rules”) and slot filters (“filters”) stored in the reservation tool databases 101, 102. Based on creation rules, the reservation tool automatically creates available sales call slots, stored in the slots database 103, that can be reserved. And based on the slot filters, the reservation tool automatically controls and manages the selection of available slots that reps are permitted to reserve. By available, we mean that a sales call slot is one that conforms to the slot creation rules. By permitted, we mean those available slots that a given rep is permitted to reserve, based on all applicable slot filters.

Reps use the reservation tool to search for slots that are both available and permitted by all applicable filters. If any available slot meets all of the applicable filters, the rep can reserve that slot. The tool may require the rep to read and/or agree to various compliance policies, office policies, meal suggestions, directions, etc., stored in an office policies database 104, prior to reserving the slot. The tool may also require the rep to provide information, such as his contact information, company, product, or sales call topic which is then stored in the rep information database 105. The tool then sends printable sales call reservation confirmations and reminders 113 to the reps using email.

Routinely (for example, every day), the reservation tool generates (using the rules and filters) and sends sign-in sheets 123 to the staff using fax 120b or email 120a, 120c. Staff can also access the sign-in sheets at anytime using a computer web browser 120a. Each sign-in sheet provides staff with information about upcoming reserved sales calls and a request form. The staff use the sign-in sheets to log sales calls and sample deliveries, manage the flow of sales calls, and indicate requests in the request form area. At the end of the day, the staff can send the sign-in sheet to a manager 140 of the reservation tool for digital archiving and request processing. In some implementations, the sign-in sheet could be provided electronically on a kiosk that displays the sheet to reps and staff and accepts input through a touch screen or a key-board.

An example of the sign-in sheet sent by the reservation tool is shown in FIG. 7. The sheet is titled with the date of delivery 700, the office 701, and the staff identification 702. The sign-in sheet includes a rep sign-in area 703 which shows available (no entry in the sales representative column) and reserved slots (an entry appears in the sales representative column), the type 704 of sales call slots, scheduled time 705 of the sales call slots, the name 706 and company 707 of the rep with a reserved slot, and a message 708 from the rep about the sales call. The sign-in sheet also includes a request form area 709 where staff can indicate product requests 710, change their creation rules 711, and send messages 712 to the reps that visit the office. The sheets are designed so that the staff can send them back to an account manager of the reservation tool for digital archiving and request processing. Each sign-in sheet created by the reservation tool includes a unique ID 713 to definitively identify the sign-in sheet when it is sent back.

Other sign-in sheet configurations could be arranged differently, and many other configurations could be provided according to the requirements of the user. Additional fields for logging information about sales calls and product sample deliveries could also be added, such as the product sample's strength, quantity, lot number, and expiration date.

The reservation tool can also recommend sets of reservations to reps and sales force managers using optimization criteria 114 (“criteria”) such as maximizing successful outcomes or maximizing visits with high-prescribers. As shown in FIG. 8, the tool creates a graph of points 810 and vectors 820 to perform the optimization. There are points for each available slot at an office the rep is interested in visiting and points for prior commitments such as slots already reserved by the rep. Each point has an optimization value and start time. The optimization value is based on the optimization criteria selected. For example, if the criteria calls for maximizing successful outcomes, each point's optimization value would be based on historical sales call data that is stored in a database 117 at the centralized location. The start time of each point is based on the start time of the slot. A vector exists between two points at different offices, if there is enough time for the rep travel from the start point to the end point. The tool can then use any of a variety well-known graph search algorithms such as A* or simulated annealing to find a recommended path 830 through the graph that maximizes the optimization criteria. The sequence of slots represented by the points are then presented to the rep for consideration.

In addition to the reps reserving time slots, the staff can use the reservation tool to request a sales call about a specific product. In this case, the reservation tool searches its records for appropriate reps based on past reservations (stored in the historical sales call database 117) and sends reservation invitations using email.

The reservation tool generates activity reports 115 for staff, reps, and sales force management. For example, the tool can generate and send a customized contact directory of all reps calling on a office. Or, the tool can generate a report of sales calls reserved by a particular company.

The tool can also generate reports and automatically send alerts for pharmacists or other staff in a hospital or health system when reps reserve slots to discuss products that are not on an approved list of drugs for the hospital or health system (“formulary”). The pharmacist could also use the tool to enforce the formulary by not allowing reps to reserve slots to promote an off-formulary product.

The reservation tool 100 is centralized as shown in FIG. 1, so that many different reps 110a, 110b may use the reservation tool to access, search, and reserve sales call time slots created by many different staff members 120a, 120b, 120c in different offices. Sales force managers 111 can manage activity or view reports on groups of their reps 112. Similarly, group office managers 121 can manage activity or view reports on groups of their staff 122 in multiple offices.

In some examples, a sales call slot can be defined as available for reservation (“available”) or as assigned to one rep (“reserved”). Each slot has a specific date, time, and class such as regular, sample delivery, lunch, breakfast, coffee break, or any other type of sales call.

To create slots, staff enters slot creation rules and slot filters into the tool, using a dialog (and example of which is shown in FIG. 2). Staff can add creation rules 210 which specify the number of slots per day 210a created by the rule, the recurring frequency 210b of the slots, the days of the week 210c the slots occur on, and the time window 210d in which the slots occur. Many rules can be entered so that any combination of slots can be created.

Staff can also create filters that limit the total number 220a of slots that can be reserved in a time period 220b or limit the frequency 230 with which each rep can reserve a slot. Many filters can be entered so as to create many combinations of dynamic limitations.

And similar rules and filters can be set for specific types of visits, such as lunches 260. The staff can also specify office policies 240, 241 that are displayed to the rep during the reservation method. The staff can also specify the fax 250a or email address 250b where the sign-in sheets will be sent. The staff can specify whether the sign-in sheets will be sent 250c if no rep has reserved a slot that day.

Other dialog configurations could be used and the dialogs could be displayed differently. Many other rules and filters could be provided according to the requirements of the user. FIG. 3 lists examples of other rules 300 and filters 310 that could be provided by the reservation tool. Rules or filters can be applied selectively to sales representations or groups of them who match certain criteria; so that, for example, only representatives with a paid subscription to the reservation service are permitted to reserve certain preferred slots.

A method of reservation is shown in FIG. 4. Staff enter slot creation rules 420 into the tool's rules database 410, and enter slot filters 421 into the tool's slot filters database 411. The tool dynamically creates 422 slots in the slots database 412, based on the creation rules. Rules typically create slots that are initially available for reservation by any rep; however, rules can also create slots that are pre-reserved for a specific rep or company. Single non-recurring slots can also be created dynamically to accommodate special situations.

As shown in FIG. 10, a rep uses the tool to request 400 a list of any available slots 1010 for a specific office 1030. The tool retrieves 401 a list of available slots from the slot database 412. The tool retrieves and applies 402 relevant filters from the filter database 411 to the list of available slots. The tool displays 403 to the rep any available slots 1010 that survive the filters, and may show filled slots 1020 that are already filled by reps. The rep selects 404 a slot to reserve. The tool displays 405 office policies for the sales call and stores the rep's agreement to those policies in the tool's policy agreement database 413. The rep enters 406 information about the sales call into the tool, such as his name, company, product, telephone number, email address, and message or topic to be discussed. The rep reserves 407 the slot and the tool updates the slots database 412 to reflect the reservation. The tool sends 408 a printable reservation confirmation and reminder to the rep using email, fax, sales force automation software, or other communication method. Up until the date of the sales call, the rep can use the tool to update the sales call information or cancel the reservation. Routinely, the reservation tool retrieves 423 slots from the slot database 412 and sends sign-in sheets 424. Staff use the sign-in sheets to manage and log sales call activity in the office. The sign-in sheets can be sent using fax, email, office automation software, or other communication method. At the end of the day, the staff can send the sign-in sheet to the manager of the reservation tool for digital archiving and to indicate requests in the request form area.

In determining the available and permitted time slots a variety of principles may be applied. Slots reserved on behalf of entities may later be assigned or reassigned to sales representatives. Wait listing for available slots on behalf the sales representatives or entities may be permitted. Stand-by status may be allowed for available slots. Reservations may be enabled to be made only during reservation time windows. Reservations may be enabled to be made only up to a minimum time prior to the time of a slot being reserved. Reservations may be enabled to be made only after a maximum time prior to the time of a slot being reserved. Reservations may be enabled to be made only based on the extent to which the sales targets' slots are filled. The conditions for making slots available or permitted may include restrictions on the number of calls of a type that can be made in a given day. At least one of the conditions may apply only to certain types of sales calls. Available slots may be limited to pre-specified sales representatives or entities.

In another example of the reservation method shown in FIG. 4, a sales force manager reserves slots for his reps far in advance of their sales calls. As the date of a sales call approaches, the manager uses the tool to update the reservation with the name of a specific rep and the message the rep will discuss. The sales force manager can thereby make detailed plans many months in advance, which enables the sales force manager to precisely and carefully optimize the schedules and travel plans of his reps during crucial product launch periods. Effective sales calling during launch periods have a very significant influence on the success of a new product. Being able to manage the sales call schedules of reps long before the first day of the launch increases the ability of the sales manager to affect the success of the launch and the product.

An alternative example of the reservation method is shown in FIG. 5. In this method, the reps can also enter optimization criteria 500 into the tool, and then request available slots for a set of offices. Example criteria include maximizing the number of slots per day, minimizing travel distance, or maximizing the odds of successful outcomes based on prior sales call reservation results. After retrieving 501 and filtering 502 available slots, the tool uses an optimization algorithm to recommend 503 a set of slots that optimize the rep's chosen criteria. The tool displays the recommended available slots 504 that survived both the filters and criteria. The rep uses the tool to reserve those slots.

In another example of the reservation method shown in FIG. 4, and just prior to step 400, the tool could use collaborative filtering techniques to recommend to the rep (“Rep A”) a set of offices that the rep should consider calling on, based on sales call reservations made by other reps using the tool. To perform this recommendation, the tool uses the slot database to retrieve a list of all reps (“Similar Reps”) who have visited the offices that Rep A has visited in the past. The tool then retrieves the list of all the offices (“Similar Offices”) that the Similar Reps call on. Each Similar Rep is given a value (“Similar Rep Value”) equal to the number of offices that the Similar Rep and Rep A both visit. Each Similar Office is then given a value (“Similar Office Value”) equal to the sum of the Similar Rep Values of the Similar Reps that call on that office. The list of Similar Offices is then sorted according to the Similar Values, and presented to the rep as recommended offices to visit.

An alternative example of the reservation method is shown in FIG. 6. In this method, the staff can request 600 a sales call about a specific product. The staff can enter the request directly into the tool, or the staff can indicate the request on the sign-in sheet and send the sign-in sheet to an account manager who enters the request 601 into the tool on the behalf of the staff. The tool retrieves 602 past sales call reservations in the geographic area of the office making the request and searches for appropriate reps who could fill the request. The tool then sends 603 reservation invitation emails to the appropriate rep(s) via email.

A rep opens 604 the email and follows a link to the reservation tool. The method continues as in FIG. 4.

The reservation tool generates activity reports 124 for staff, group office managers of staff, reps, and sales force management. For example, the tool can generate and send a customized contact directory of all reps calling on a office. Or, the tool can generate a report of sales calls reserved 125 by a particular company.

A block diagram of hardware used to implement the invention is shown in FIG. 9. The tool software is hosted on a web server 910 with a database storage drive 911 that is connected to the Internet 920. Users access the reservation tool using a web browser or other client application on a personal computer 941 with a monitor 940 and input devices such as a keyboard 942 and mouse. The reservation tool can communicate through the Internet 920 with third party application servers 960 hosting sales force automation software or office automation software. The reservation tool can also send faxes by communicating through the Internet with Internet Fax Servers that then send faxes through the public phone network 921 to fax machines 930. The reservation tool can also connect with personal digital assistants 950 using personal computers or wirelessly via the Internet.

A block diagram of the reservation tool application architecture is shown in FIG. 11. The user uses a personal computer 1121 to access the reservation tool server 1100 through a Web browser 1122 and the Internet 1119. The request from the browser goes to the Apache Web Server 1117, which sends the request to the reservation tool application 1102 through the Tomcat Java application server 1101. The reservation tool application matches the request to a reservation tool Java Server Page 1103, which makes use of the following subsystems. The reservation tool JSP tag library 1004 provides Java Server Page tags to allow high-level integration of the underlying subsystems into the reservation tool Java Server Pages 1103. The Sun core tag libraries 1005 provide Java Server Page tags to simplify the development of the reservation tool Java Server Pages 1103. The slots and filters subsystem 1106 creates slots, provides lists of slots, filters slots, reserves slots, and cancels slots. The rep subsystem 1107 stores and retrieves rep contact, product, company, and other information. The office subsystem 1109 stores and retrieves office contact information, directions, policies, and other preferences. The connected application library 1108 interacts with external connected application servers 1118 through the Internet. The authentication subsystem 1110 accepts login information and applies security. The activity logging subsystem 1111 logs interesting events that happen in the reservation application. The reporting subsystem 1112 generates reports for sales reps, rep manager, office staff, and reservation tool managers. The email/fax subsystem 1113 sends emails and faxes from the reservation tool application. Faxes are sent through an Internet fax service. The SimpleORM subsystem 1114 provides database access to the MySQL database 1120 and caches database objects. The reservation tool Java utils 1115 is a utility library used by the other subsystems. The iText PDF generator 1116 creates PDF files, such as sign-in sheets.

The reservation tool accepts passwords to protect account access by staff, reps, and their managers.

The use and impact of the reservation tool is broader than the automating of specific manual tasks for sales reps and medical offices as explained above. When its many functions are combined, the reservation tool enables an entirely new sales call process for an industry in which sales productivity has been declining, for example, the pharmaceutical industry.

Pharmaceutical company sales force productivity has declined significantly in recent years. A typical $130,000/year pharmaceutical sales representative talks to only 2.6 physicians a day, usually for less than 90 seconds each. The rest of his day is spent waiting in lobbies with competitors. The goal is greater success in getting past the front desks that guard physicians.

Medical groups, on the other hand, are overwhelmed by the volume of calls requested and made by sales reps. There may be, for example, five persistent sales reps for each high-prescribing physician. A solo practitioner can receive requests for more than 100 sales calls per month, far more than the physician is willing to accept. As a result, front desk staff now block 80% of all sales calls. Reps must therefore call on a physician an average of five times in order to speak with her once.

The reservation tool replaces the random, brute-force one by one cold calling process with an ordered, predictable, efficient selling process. This produces great benefits for both the medical offices and the pharmaceutical companies. In general, the reservation tool can reduce the cost and improve the effectiveness of sales calling efforts of the reps while reducing the burden and improving the quality of the calls for the physicians.

While most medical offices don't have the resources (or desire) to organize sales calls manually, the reservation tool allows them to set up rules and filters that automate the process. Medical offices then can be highly responsive to the limited number of time slots they have made available to reps. Reps who collaborate with the medical office, and reserve time slots that are mutually convenient, experience sales calls that are dramatically more successful and less time consuming.

For medical offices, the reservation tool is a time-saving service that eliminates daily hassles. It eliminates the queue of reps in the lobby that distracts staff and crowds patients and the time consuming process of turning away reps. And, it automates routine tasks like requesting product samples and maintaining a rep rolodex.

For sales reps, the reservation tool is a powerful device for selling to physicians. The reservation tool solves the front desk problem, increasing sales call success rates from below 20% to virtually guaranteed, while reducing lobby wait-times from hours to minutes. Each sales call is now successful, so reps no longer need to visit an office five times to see a physician once.

The reservation tool will therefore enable sales forces to call on many more physicians with a fraction of the sales reps required today, saving the industry billions of dollars each year. And increasing the expected outcome of sales calls does more than simply sales rep save time. The tool enables sales forces to invest more energy into each sales call. Managers can spend more time deciding which sales rep a physician should see each week or month, and what the message should be. Ordinary reps can spend more time preparing for each call. And more highly-trained specialists or scientists can be fielded to provide more detailed information. All of which further increases the value of sales calls to physicians, which increases their desire to engage in the call.

A database definition of data stored by the system and computer program listings in HTML, PHP, Java, and JavaScript, for the ssytem are set forth on a CD-ROM being submitted as an appendix to this application and are incorporated by reference here. The files contained on the CD-ROM, all in ASCII format, are called iText.txt, PreferredTime.txt, RepWireJava.txt, schema.txt, and simpleORM.txt.

iText.txt includes an open-source Java library for the generation of Adobe PDF files, with some bug fixes. SimpleORM.txt contains an open-source Java library for database access, with some bug fixes. RepWireJava.txt contains a proprietary Java library that provides the service functionality. PreferredTime.txt contains a Java Web application that provides the user interface to the service. schema.txt contains an SQL script for the MySQL database server. All of the libraries are packaged, along with a web application, into a standard web application archive (WAR) file. The WAR file is deployed into any commercial or open-source Java Web application container, such as Jakarta Tomcat or IBM Websphere. The database is deployed to the open-source MySQL database server, which is connected to the Java Web application container using the standard connector provided by MySQL.

Other implementations are also within the scope of the claims.

Although the example discussed above refer to medical offices and the sales representatives who call on them, the same techniques could be applied to offices, staff, and sales representatives in other industries as well.

1. A method comprising
automatically generating available slots for sales calls to be made by sales representatives to sales targets, and
enabling reservations for one or more of the available slots to be made electronically on behalf of one or more sales representatives or entities represented by the sales representatives,
in connection with enabling reservations for slots, receiving from the sales representative or the entity, a message concerning the sales call.

2. The method of claim 1 in which the message relates to products to be discussed in the sales call.

3. The method of claim 1 including interfacing with a sales force automation system.

4. The method of claim 1 in which the available slots comprise time slots.

5. The method of claim 1 in which one or more users are enabled to specify conditions for generating the available slots.

6. The method of claim 5 in which the the one or more users comprise staff of the sales targets.

7. The method of claim 1 also including electronically delivering sign-in lists to the sales targets based on the slots.

8. The method of claim 5 in which the conditions comprise rules.

9. The method of claim 5 in which the conditions relate to time.

10. The method of claim 5 in which the conditions comprise specified days or times.

11. The method of claim 5 in which the conditions relate to a number of slots per period.

12. The method of claim 5 in which the conditions relate to generation of ad hoc slots created in real time.

13. The method of claim 1 in which the reservations are automatically made for fixed recurring times.

14. The method of claim 5 in which the conditions comprise limits on frequency of slots per sales representative or per entity represented by the sales representatives.

15. The method of claim 5 in which the conditions comprise limits on a percentage of slots that can be reserved on behalf of a sales representative or an entity represented by the sales representatives.

16. The method of claim 5 in which the conditions comprise limits on the number of slots per time period for a given sales target.

17. The method of claim 1 in which slots reserved on behalf of entities are later assigned or reassigned to sales representatives.

18. The method of claim 1 also including enabling wait listing for available slots on behalf the sales representatives or entities.

19. The method of claim 1 in which the reservations are enabled to be made only up to a minimum time prior to the time of a slot being reserved.

20. The method of claim 1 in which the reservations are enabled to be made only after a maximum time prior to the time of a slot being reserved.

21. The method of claim 1 in which the reservations are enabled to be made based on an extent to which the sales targets' slots are filled.

22. The method of claim 5 in which the conditions include restrictions on the number of calls of a type that can be made in a given day.

23. The method of claim 5 in which at least one of the conditions applies only to certain types of sales calls.

24. The method of claim 1 also including providing reports of sales calls completed or planned.

25. The method of claim 1 also include providing reports of sales calls completed or planned, by matching sales representative products against a sales target's formulary.

26. The method of claim 1 also comprising automatically generating a directory of sales representatives based on reservations for available slots.

27. The method of claim 1 in which entities represented by the sales representatives comprise pharmaceutical companies, and in which the method also includes reporting information about sales calls to the pharmaceutical companies.

28. The method of claim 1 comprising communicating invitations for available slots to the sales representatives or entities.

29. The method of claim 1 in which the conditions comprise rules that define available slots and filters that define permitted uses of the available slots by the sales representatives.

30. A method comprising
based on stored information about electronically reserved slots for sales calls to be made by sales representatives to sales targets, providing, electronically at a site at which the calls are to be made, displayable schedules of the sales calls, and
generating information about completed sales calls appearing on the schedules.

31. A method comprising
enabling staff of physicians to electronically define conditions for generating slots for sales calls to be made by sales representatives of pharmaceutical or medical device companies on the physicians at places where the physicians are located,
enabling the sales representatives electronically to make reservations for generated slots,
generating information about slots that have been reserved for use at the places where the physicians are located,
enabling information to be added to the generated information with respect to completed sales calls, and
returning the added information to a central location for storage and future use.

32. A method comprising
on pre-generated lists of reserved slots for sales calls to be made by sales representatives to sales targets places where the sales targets are located, obtaining information about the sales calls, and
providing the pre-generated lists and obtained information electronically to a central location from the different places.

33. The method of claim 32 in which the obtained information includes information about at least one of the following: samples of products that interest the sales targets, notes about the sales calls, and messages for the sales representatives or the sales targets.

34. The method of claim 1 also including the sales target requesting samples of products in connection with the visits.

35. The method of claim 34 also including automatically selecting sales representatives based on past call activity, and
automatically sending invitations for available slots to the sales representatives.

36. A method comprising
electronically delivering from a central location to places at which sales representatives are scheduled to make sales calls on sales targets, schedules of slots for the sales calls, and
after the schedules are delivered, electronically receiving from the places at the central location information about the sales calls,
the delivered schedules including lists of the slots and a mechanism for recording product samples associated with the sales calls.

37. The method of claim 36 in which the schedule also includes a mechanism to record preferences regarding future sales calls.

38. The method of claim 36 in which the schedule also includes a mechanism to record messages.

39. A method comprising
a pharmaceutical company sending sales representatives to call on physicians for sales slots that have been reserved using an electronic reservation mechanism that matches slots for which the physician commits to be available for such sales representatives and communicates with a sales force automation system.

40. A method comprising
a physician making himself available for sales slots for sales representatives of pharmaceutical companies that have been reserved using an electronic reservation mechanism in which conditions for availability of the sales slots to the sales representatives are controlled on behalf of the physician and which automatically generates a directory of sales representatives.

41. A method comprising
enabling one or more users to define conditions for generating slots for sales calls to be made by sales representatives to sales targets,
enabling reservations of one or more of the slots to be made electronically on behalf of one or more sales representatives or entities represented by the sales representatives, and
automatically delivering for use on behalf of the sales targets information about slots that have been reserved, on behalf of sales representatives or the entities, with respect to the sales targets.

42. A method comprising
enabling a user to define a condition for generating in real time ad hoc slots for sales calls to be made by sales representatives to a sales target,
enabling reservations of one or more of the ad hoc slots to be made electronically on behalf of one or more sales representatives or entities represented by the sales representatives, and
automatically delivering, for use on behalf of the sales target, a list of the ad hoc slots and reservations.

43. A method comprising
with respect to one or more slots for sales calls that are to be made by sales representatives to a sales target, enabling reservations to be made automatically for fixed recurring times on behalf of one or more sales representatives or entities represented by the sales representatives.

44. A method comprising
enabling a user to define a condition for generating slots for sales calls to be made by sales representatives to a sales target, the condition comprising a limit on an amount of slots that can be generated, and
enabling reservations of one or more of the slots to be made electronically on behalf of one or more sales representatives or entities represented by the sales representatives.

45. The method of claim 44 in which the conditions comprise limits on frequency of slots per sales representative or per entity represented by the sales representatives.

46. The method of claim 44 in which the conditions comprise limits on a percentage of slots that can be reserved on behalf of a sales representative or an entity represented by the sales representatives.

47. The method of claim 44 in which the conditions comprise limits on the number of slots per time period for a given sales target.

48. A method comprising
automatically generating slots for sales calls to be made by sales representatives to a sales target,
enabling reservations of one or more of the slots to be made electronically on behalf of one or more sales representatives or entities represented by the sales representatives, and
adjusting the assignments of slots after the reservations have been made.

49. The method of claim 48 also including enabling wait listing for available slots on behalf the sales representatives or entities.

50. A method comprising
automatically generating slots for sales calls to be made by sales representatives to a sales target,
enabling reservations of one or more of the slots to be made electronically on behalf of one or more sales representatives or entities represented by the sales representatives, and constraining the time period during which reservations for slots may be made.

51. The method of claim 50 in which the reservations are enabled to be made only up to a minimum time prior to the time of a slot being reserved.

52. The method of claim 50 in which the reservations are enabled to be made only after a maximum time prior to the time of a slot being reserved.

53. A method comprising
automatically generating slots for sales calls to be made by sales representatives to a sales target,
enabling reservations of one or more of the slots to be made electronically on behalf of one or more sales representatives or entities represented by the sales representatives, the reservations being enabled to be made based on an extent to which the sales targets' slots are filled.

54. A method comprising
enabling a user to define a condition for generating slots for sales calls to be made by sales representatives to sales targets, and
enabling reservations of one or more of the slots to be made electronically on behalf of one or more sales representatives or entities represented by the sales representatives,
the condition applying only to certain types of the sales calls.

55. A method comprising
automatically generating available slots for sales calls to be made by sales representatives to a sales target, the available slots being limited to prespecified sales representatives or entities. and
enabling reservations of one or more of the slots to be made electronically on behalf of one or more sales representatives or entities represented by the sales representatives.

56. A method comprising
enabling a user to define a condition for generating slots for sales calls to be made by sales representatives to a sales target, and
optimizing a schedule of the slots subject to the defined condition.

57. A method comprising
automatically generating available slots for sales calls to be made by sales representatives to sales targets, and
automatically providing recommendations to the sales representatives or entities which they represent to reserve slots with respect to an identified sales target.

58. The method of claim 57 in which the identified sales targets are identified based on historical information about sales calls made to sales targets.

59. A method comprising
enabling reservations of one or more slots for sales calls to be made electronically on behalf of one or more sales representatives or entities represented by the sales representatives, the sales calls being calls to a sales target,
automatically generating information about sales call slots based on the reservations, and
exposing advertising to the sales target or the user in connection with the enabling of the reservations or the use of the generated information.

60. A method comprising
enabling a user to define a condition for generating slots for sales calls to be made by sales representatives to sales targets, and
enabling reservations of one or more slots for sales calls to be made electronically on behalf of one or more sales representatives or entities represented by the sales representatives, the sales calls being calls to a sales target, and
reporting information related to the sales calls to the sale representatives, the entities, or the sales targets.

61. A method comprising
automatically generating available slots for sales calls to be made by sales representatives to a sales target,
enabling reservations of one or more slots for sales calls to be made electronically on behalf of one or more sales representatives or entities represented by the sales representatives, and
automatically providing reminders to the sales representatives or entities which they represent, in advance of the times of the slots.

62. A method comprising
automatically generating available slots for sales calls to be made by sales representatives to sales targets,
enabling reservations of one or more slots for sales calls to be made electronically on behalf of one or more sales representatives or entities represented by the sales representatives, and
automatically generating invitations for available slots to sale representatives.

63. A method comprising
enabling a user to specify rules for available slots for sales calls to be made by sales representatives to sales targets,
applying filters to the available slots to define permitted uses of the available slots by particular sales representatives or entities that they represent, and
enabling reservations of one or more slots for sales calls to be made electronically on behalf of one or more sales representatives or the entities.
